(19) United States
(12) Patent Application Publication
(10) Pub. No.: US 2019/0037838 A1
(43) Pub. Date: Feb. 7, 2019

(54) POWDERY FORMULATIONS WITH SURFACE ACTIVE SUBSTANCES ON SOLID, WATER-SOLUBLE CARRIERS, METHOD FOR THE PRODUCTION AND USE THEREOF

(71) Applicant: Evonik Degussa GmbH, Essen (DE)

(72) Inventors: Michael KLOSTERMANN, Essen (DE); Ewald SIEVERDING, St. Johann (DE); Rene HAENSEL, Dorsten (DE); Joachim VENZMER, Essen (DE)

(73) Assignee: Evonik Degussa GmbH, Essen (DE)

(21) Appl. No.: 16/072,071

(22) PCT Filed: Jan. 11, 2017
(86) PCT No.: PCT/EP2017/050447

§ 371 Date: Jul. 23, 2018

(30) Foreign Application Priority Data
Feb. 2, 2016 (EP) 16153788.1

(51) Int. Cl. A01N 25/12; A01N 25/30; A01N 25/10

(52) U.S. Cl. CPC A01N 25/12; A01N 25/10; A01N 25/30

(57) ABSTRACT

The invention relates to solid, powdery compositions comprising at least one solid, water soluble carrier and at least one surface-active substance, and to a method for the production and use thereof in an aqueous solution.

The invention provides solid pulverized compositions comprising at least one solid water-soluble carrier and at least one interface-active substance, processes for production thereof and use in aqueous solution.

Crop protection compositions (also called pesticides hereinafter) are frequently employed in crop protection, in pest control and in the industrial sector. These may be, for example, herbicides, fungicides, insecticides, growth regulators, molluscicides, bactericides, virucides, micronutrients and biological crop protection compositions based on natural products or living or processed microorganisms. Active pesticidal ingredients are listed in connection with their fields of use, for example, in The Pesticide Manual', Sixteenth Edition, 2012, editor: C. MacBean; biological active ingredients are specified, for example, in The Manual of Biocontrol Agents', 2001, The British Crop Protection Council. “Pesticide” is always used as a collective term hereinafter.

In practice, crop protection compositions are often added to a tank with water as an ingredient and distributed in what is called the spray liquor with gentle stirring, in order to dilute the concentrated formulation of the active ingredient prior to spraying and to make it tolerable for the plants. Typically, the active ingredient is diluted here in the spray liquor to such an extent that a final use concentration between 2 and 4000 g/h is achieved on spraying.

An important criterion for crop protection formulations here is that they have to be converted to formulation forms that are practicable for the user, it being necessary to ensure that the active pesticidal ingredient in the chosen formulation form can optimally fulfil its actual task, for example a herbicidal, insecticidal or fungicidal effect. The type of formulation plays a major role; it ensures that the farmer receives an administration form of the active ingredient which is safe and easy to handle and also effective, and which permits him to easily incorporate the crop protection formulation into the spray liquor.

Since active ingredients for crop protection can often differ distinctly in terms of their physicochemical properties, various formulation concepts have been developed for provision of crop protection formulations. All these formulation concepts are subject to strict regulations, with regard to environmental behaviour, crop compatibility and toxicity. Moreover, commercial products, according to Cipac MT 46, must have adequate storage stability.

If the active ingredient is fully water-soluble and chemically stable, the water-soluble concentrate is the simplest form (abbreviation: SL). In the case of products which are insoluble in water but soluble in suitable solvents, what are called emulsion concentrates (abbreviation: EC) are an option. Here, the agriculturalist obtains a product in which all formulation constituents form a homogeneous solution. Only on dilution with water does an emulsion form, which then, like all formulations, is applied with 100-1000 l of water per hectare. In this formulation concept, the solubility and chemical stability of the active materials in the solvent are of crucial significance. The solvent affects not least important properties such as adhesion and retention of the spray liquor on the plant and penetration in the plant, which also partly determines the biological action.

However, many active ingredients cannot be formulated as an EC or SL. This is either because no suitable solvents have been found for these active ingredients, or else alternative formulation concepts are necessary for the absorption and distribution of the active ingredient in the plant. Particularly in the case of insecticides, it may be advisable to obtain the active ingredient in particulate form, in order to achieve high contact and feeding action via the crystalline form. Reference is made to suspension concentrates (abbreviation: SC) when the active ingredient is in ultrafine distribution in solid form in water. If the carrier is an oil, the person skilled in the art makes reference to oil dispersions (abbreviation: OD).

In addition, it is customary to add insoluble solid active ingredients in solid form to the spray liquor. This used to be done in the form of what are called wettable powders (abbreviation: WP). This is no longer a standard operation nowadays because of dust formation. Therefore, water-dispersible granules (abbreviation: WGs, or WDGs, e.g. Atlantis WG from Bayer) are now used. WDGs enable use of the active ingredients in dust-free form. The WDGs are added to the spray liquor and are readily water-dispersible by virtue of additives such as wetting agents. As well as the active ingredient, which may account for 5%-80% of the formulation, WDGs usually include further additives which do not themselves have any crop protection effect but improve at least one of the properties of the crop protection formulation, and additionally fillers or free-flow aids. Examples of common additives used in crop protection formulations are wetting agents and dispersants, defoamers or anti-drift additives. One feature common to the additives mentioned here is that they are interface-active substances, meaning that they display their effect at interfaces. These interfaces are, for example, solid-liquid interfaces in the case of wetting agents and dispersants (for example interface between crop protection formulation and plant) or liquid-air interfaces in the case of defoamers and anti-drift agents.

WO 2005/104846 discloses solid, water-soluble, supported formulations comprising flonicamid, a dispersant and a surfactant. The supporting material is selected from monomeric sugars, starches and water-soluble salts.

Additives which improve the biological efficacy of pesticides or pesticide mixtures are also commonly referred to as adjuvants. Efficacy is frequently also referred in this connection to as effectiveness. The Pesticides Safety Directorate (PSD, the executive branch of the Health and Safety Executive, a non-governmental public organization in Great Britain) defines an adjuvant as a substance which is not itself pesticidally active but increases or promotes the effectiveness of a pesticide. (http://www.pesticides.gov.uk/approvals). This can be demonstrated by field trials. With regard to the use of the word adjuvant, patents or the literature often use the terms surfactant or wetting agent synonymously, but these are much too wide-ranging and can therefore be interpreted as more of an umbrella term. Because of the use envisaged here, the term “adjuvant” is employed.

In practice, there are numerous crop protection active ingredients which achieve acceptable effectiveness, i.e. practically relevant efficacy, only with the aid of adjuvants. The adjuvants help here to compensate for the weaknesses of the active ingredient, for example the UV sensitivity of avermectins (destroyed by ultraviolet radiation) or the water instability of sulphonylureas. More recent active ingredients are generally water-insoluble and, in order therefore to be able to spread effectively over a target=target organism=plant, adjuvants are indispensable for the aqueous spray liquor, in order to compensate for the poor wetting of surfaces by way of the physical influence on the aqueous solutions. In addition, adjuvants help to overcome technical application problems, such as low water application rates, different water qualities and the trend to increased application rates. The increase in pesticide efficacy and the compensation for weaknesses in the crop protection compositions by adjuvants is generally referred to as enhancing the effectiveness of the crop protection composition application.

Adjuvants used are frequently synthetic surfactants, for example ethoxylated alcohols or alkyl polyglycosides. A further important group of adjuvants used is frequently that of organosilicones, especially trisiloxane surfactants of the general structure Me₃SiO—SiMeR—OSiMe₃ where the R radical is a polyether radical. These significantly lower the surface tension of water and hence improve the sticking of the spray liquor on the leaf (adhesion, retention) and the absorption of the active ingredients through the stomata and also through the cuticle (see, for example, Field & Bishop in Pesticide Science, 1988, vol. 24, pp.55-62; Stevens et al. in Pesticide Science, 1991, Vol.33, pp. 371-82). The surface tension-lowering effect of trisiloxanes on water is much more marked here than in the case of organic surfactants used in the past, for example nonylphenol ethoxylates. Furthermore, it is known to those skilled in the art that trisiloxane surfactants having not more than 10 ethylene oxide units in particular have a superspreading effect on spray liquors; this distinctly improves the effectiveness of crop protection compositions. Superspreading is understood to mean the ability to cause a droplet to spread over an area about 9 times greater than a droplet of distilled water on a hydrophobic surface (for example leaf of plants).

By contrast with adjuvants, the task of defoamers is to prevent the undesired formation of foam, for example during the tank mix operation when making up spray liquors (see, for example, U.S. Pat. No. 5,504,054 A). Standard defoamers used in the agricultural sector are often based here on polyether-modified polydimethylsiloxanes. Moreover, silicone-free defoamers, which contain vegetable oils, for example, as active defoamer ingredient, are also used in agriculture applications.

Anti-drift additives in turn have the property of affecting the droplet size distribution of the spray produced on spraying of the crop protection formulation over the agricultural area to be cultivated to the effect that droplet sizes less than 150 μm are very substantially avoided. The reason for this is that such small droplets are particularly prone to drift, meaning that they are transported away from the actual application site by gentle air flows and thus have an increased tendency to “off-target” deposition. This in turn leads to high environmental pollution for the surrounding area and to economic losses.

The tasks of additives in crop protection formulations are not always clearly separated. Thus, it is entirely possible that an additive can assume several tasks. PCT/EP2015/061055, for example, describes the simultaneous use of defoamers as anti-drift agents. EP 14188067 describes the use of hydrophobic polyglycerol esters as adjuvant and anti-drift agent.

Usually, WDGs are produced by spray-drying an aqueous slurry containing all the essential constituents of the WDGs. (Fluid bed granulation of a slurry, continuous process). In the case of admixture of additives to such a slurry, there may often, however, be processing disadvantages. For instance, the incorporation of many water-soluble surfactants is often found to be difficult because of significant foaming. This is the case particularly when trisiloxanes are used. Furthermore, it is possible that water-soluble surfactants, after the drying of the slurry, can be absorbed virtually irreversibly on solids present in the WDG (for example fillers or free-flow aids), as a result of which they almost completely lose efficacy during later use. This phenomenon is usually also observed when the surfactant is applied subsequently to the finished WDG formulation (for example by spraying).

In the case of incorporation of defoamers into WDG formulations, by contrast, the problem can occur that they are incompatible or only partly compatible with the aqueous slurry in these chosen concentrations, resulting in inhomogeneous distribution of the active defoamer ingredient in the WDG during production. Furthermore, in the case of defoamers too, the problem can occur that after drying they are adsorbed on solid constituents of the WDGs, which likewise results in a loss of efficacy.

In principle, it would be possible to get round this problem by means of solid pulverized additives which are added to the WDGs in the dry state. In the past, therefore, a series of products in which additives for crop protection formulations were applied to solid, water-insoluble carriers (often silica carriers) was developed. One example of these is the Break-Thru® S 250 DS product, which consists of a trisiloxane adsorbed onto a silica carrier. However, a disadvantage of this product class is that the carrier only partly releases the additive, which likewise leads to a decrease in the action thereof. Furthermore, there is the risk that the carrier, which is insoluble in the spray liquor, will lead to blockage of the spray nozzles during application. Moreover, the silica carrier can be adsorbed on the walls of the tank in which the spray liquor is present, which leads to contamination.

Additives for crop protection formulations which are applied completely to or introduced completely into a water-soluble carrier are not disclosed in the prior art.

The problem addressed by the present invention was therefore that of providing novel solid additives for crop protection formulations which overcome at least one drawback detailed in the prior art.

### DESCRIPTION OF THE INVENTION

It has been found that, surprisingly, this problem can be solved by means of compositions composed of additives embedded into a solid water-soluble carrier.

The present invention therefore provides solid pulverized compositions comprising at least one solid water-soluble carrier and at least one interface active substance, characterized in that the water-soluble carrier is a polymeric material selected from
(a) homopolymers based on and copolymers containing two or more monomers selected from the group of ethylene oxide and other alkylene oxides, ethylene glycol or other alkylene glycols, ethyleneimine, (meth)acrylic acid, (meth)acrylamide, aminoalkyl (meth)acrylate, hydroxyethyl (meth)acrylate, vinyl alcohol, vinylpyrrolidone, vinylimidazole
(b) cyclodextrins, e.g. β-cyclodextrin
(c) cellulose derivatives, for example xanthan gum, cellulose acetate, methylcellulose, ethyl methylcellulose, hydroxyethyl methylcellulose, hydroxyethyl cellulose, hydroxypropyl cellulose, ethyl hydroxyethyl cellulose, carboxymethyl cellulose.

The compositions of the invention have the advantage that the water-soluble carrier dissolves completely in the aqueous solution during use and hence the additive is released completely. In this way, losses of efficacy in particular are avoided.

The complete dissolution of the water-soluble carrier in the aqueous solution has the advantage, moreover, that there is no possibility of pre-blockage of the spray nozzles in spray applications, as known, for example, in the case of use of silica as carrier substance for adjuvants in the agrichemical sector.

A further advantage is that, after the dissolution of the compositions of the invention, all equipment can be cleaned with water to free it of residues.

The invention further provides a process for producing the compositions according to the invention.

The invention further provides for the use of the compositions of the invention and the process products of the invention in aqueous solution.

The subject-matter of the invention is described by way of example hereinafter, without any intention that the invention be restricted to these illustrative embodiments. Where ranges, general formulae, or classes of compound are stated below, these are intended to comprise not only the corresponding ranges or groups of compounds explicitly mentioned, but also all subranges and subgroups of compounds which can be obtained by extracting individual values (ranges) or compounds. Where documents are cited for the purposes of the present description, the entire content of these is intended to be part of the disclosure of the present invention. References hereinbelow to percentages are, unless otherwise stated, weight percentages. In the case of compositions, the % data are based on the entire composition unless otherwise stated. Where average values are stated below, unless otherwise stated these are mass averages (weight averages). Where measured values are stated below, unless otherwise stated these measured values were determined at a pressure of 101 325 Pa and at a temperature of 25° C.

The specification of a mass ratio of, for example, component (a) to component (b) of 0.1 means that a mixture comprising these two components

contains 10% by weight of component (a) based on the total mass of components (a) and (b).

Within the scope of the invention, interface-active substances are understood to mean those which cause effects at the air/water phase interface such as lowering of the surface tension of the water phase or foam inhibition, or bring about, at the water phase/hydrophobic solid surface interface, a decrease in the critical angle of a droplet of the water phase on the hydrophobic solid surface up to and including superspreading of the droplet.

A solid carrier is understood within the scope of the present invention to mean that this substance is in the solid state of matter between +40 and −20° C.

A water-soluble carrier is understood to mean that this substance is completely soluble between +10 and +40° C. in water at least to an extent of 5% by weight based on the mass of this solution.

A solid water-soluble carrier is understood to mean that a substance is in the solid state of matter between +40 and −20° C. and is completely soluble between +10° C. and +40° C. in water to an extent of at least 5% by weight, based on the mass of this solution.

A hydrophobic solid surface is a natural and/or synthetic surface which is solid in the temperature range between +40° C. and −20° C., and on which a droplet of water forms a contact angle in the range from 91° to 180°, preferably in the range from 100° to 170°, more preferably in the range from 105° to 150°. The contact angle of the droplet on the surface can be determined, for example, as described in the standard method ASTM D 7334-08 (2013).

In the case of superspreaders, definition by the contact angle is no longer meaningful since the changes are too small. Preferably, solutions of a superspreader are characterized in that a droplet having a volume of 50 μl of a 0.1% solution in water on a hydrophobic surface has at least a diameter of 6 cm. Preferably, the surface is a polypropylene film.

Preferred homopolymers include polyvinyl alcohol, poly(meth)acrylic acid, poly(meth)acrylamide, polyvinylpyrrolidone, polyhydroxyethyl(meth)acrylate, polyaminoalkyl(meth)acrylate, polyvinylimidazole, polyethyleneimine or polyethylene glycol.

Copolymeric carrier materials are preferably statistical copolymers.

“Statistical” means that the distribution of the different monomer units in the polymer chain is random. The copolymer may, however, also take the form of a block copolymer in which the polymer chain has relatively long sequences of the different monomer units, or of a graft polymer in which blocks of one monomer are polymerized onto the skeleton of another monomer.

Particular preference is given to polymeric carriers selected from the group comprising polyethylene glycol, polyvinyl alcohol, polyvinylpyrrolidone and hydroxypropyl cellulose. More particularly preferred in this context are carrier materials based on polyethylene glycol. Especially preferred are the carrier materials polyethylene glycol.

The indices reproduced in the formulae (I) to (IV) given here, and the value ranges for the specified indices, are understood as average values of the possible statistical distribution of the structures and/or mixtures thereof that are actually present. This applies even to structural formulae which as such, per se, are reproduced exactly.

Further preferably, the polymeric carrier materials have a molar mass in the range of 600-20 000 g/mol, more preferably of in the range of 1000-15 000 g/mol, especially preferably in the range of 2000-10 000 g/mol. The molar mass of the polymers can be determined by the prior art methods, preference being given to determining the molar mass by gel permeation chromatography. Particular preference is given to determining the molecular weights, especially the weight-average molar masses Mw, by means of gel permeation chromatography analyses (GPC) with a Hewlett-Packard 1100 instrument, using an SDV column combination (1000/10 000 A, each 65 cm, internal diameter 0.8 cm, temperature 30° C.), THF as mobile phase with flow rate 1 ml/min and RI detector (Hewlett-Packard). The standard used is a polyethylene glycol having molar masses in the range from 100 to 45 000 g/mol.

More preferably, the solid water-soluble carrier is a polyethylene glycol having a molar mass of 2000-10 000 g/mol, more especially preferably still a polyethylene glycol having bis-terminal hydroxyl substitution with a molar mass of 2000-10 000 g/mol.

In addition, preferred polymeric carrier materials have a melting point in the range of 40-200° C., more preferably in the range of 45-150° C., especially preferably in the range of 50-100° C.

Particular preference is given in the context of the present invention to using polymeric carrier materials having a molar mass in the range of 2000-10 000 g/mol and a melting point in the range of 50-100° C.

Preferably, in the compositions of the invention, the water-soluble carrier is laden with 1%-75% by weight, more preferably with 3%-50% by weight, especially preferably with 5%-40% by weight, of interface-active substances. The concentration figures are based here on the overall composition.

Preferred compositions of the invention contain, as solid water-soluble carrier, a polyethylene glycol having a molar mass of 2000-10 000 g/mol and, as interface-active substance, a polyether siloxane, more preferably a polyethylene oxide-polypropylene oxide-modified polyether siloxane.

In a preferred embodiment, the composition of the invention contains, as well as the solid water-soluble carrier, an adjuvant as interface-active substance. Advantageously, the effectiveness of a crop protection formulation formulation is increased in this way.

More preferred compositions of the invention contain, as solid water-soluble carrier, a polyethylene glycol having a molar mass of 2000-10 000 g/mol and, as adjuvant, a polyether trisiloxane, more preferably a polyethylene oxide-polypropylene oxide-modified polyether trisiloxane.

In a likewise preferred embodiment, the composition of the invention contains, as well as the solid water-soluble carrier, a defoamer as interface-active substance. Advantageously, the foaming of a crop protection formulation formulation (for example when making up the crop protection formulation) is reduced or suppressed in this way.

Preferably, the interface-active substances are selected such that they are finely dispersed in the solid water-soluble carrier, preferably soluble to give a clear solution.

The dispersion is separation-stable above the melting point of the carrier and, more particularly, no phase separation occurs. More preferably, the interface-active substances are soluble in the carrier and form a clear solution above the melting point of the carrier.

The fine dispersibility of the interface-active substance in the carrier is advantageous, since the aqueous solutions made up therefrom lead to particularly fine distribution of the additive in the water without any need for vigorous mixing.

It has been found that, surprisingly, particularly trisiloxanes and polyethersiloxanes have high compatibility with polymeric carrier materials, especially with polyethylene glycol-based carrier materials. Such good compatibility and the advantages that result therefrom were not obvious, nor have they been disclosed to date in the prior art.

Adjuvant:

If the composition of the invention includes an adjuvant as interface-active substance, this adjuvant is preferably selected from the class of the trisiloxane surfactants, especially preferably from the class of the polyether-modified trisiloxane surfactant. Very particular preference is given here to polyethylene oxide-polypropylene oxide-modified trisiloxanes.

Especially preferred are trisiloxane surfactants of the formula (I):

MₐD_{b}D′_{c} Formula (I)

with M=R¹₃SiO_{1/2}, D=R¹₂SiO_{2/2}, D′=R¹R²SiO_{2/2},

where

a is 2,

b is from 0 to 0.1, preferably 0,

c is from 1.0 to 1.15, preferably from 1.0 to 1.10, especially preferably from 1.00 to 1.05,

R¹ are independently hydrocarbyl having 1 to 8 carbon atoms, preferably methyl, ethyl, propyl or phenyl radicals, especially preferably methyl radicals,

R² is independently a polyether radical of the formula (II)

—R³O[CH₂CH₂O]ₘ[CH₂CH(CH₃)O]ₙ R⁵ Formula (II)

where

m=3.4 to 11.0, preferably 3.6 to 9.9, more preferably 4.5 to 8.5,

n=2.5 to 8.0, preferably 2.7 to 7.5, more preferably 3.0 to 6.0,

but with the provisos that:

m/n=0.44 to 3.08, preferably 0.55 to 3.00, more preferably 0.8 to 2.9, even more preferably more than 1.2 up to 2.85, especially preferably 1.9 to 2.8,

R³ are independently divalent hydrocarbyl radicals having 2 to 8 carbon atoms, preferably ethylene, propylene, 1-methylpropylene, 1,1-dimethylpropylene radical, especially preferably —CH₂CH₂CH₂—,

R⁵ are independently hydrocarbyl radicals having 1 to 16 hydrocarbons or hydrogen, preferably hydrogen or methyl, especially hydrogen.

Preferably, the polyether radical, calculated without R³O and calculated without R⁵, has a molar mass M (PE) calculated by 44 g/mol*m+58 g/mol*n where the indices m and n relate to formula (II).

The preferred values of M (PE) are: lower limits M (PE) greater than 520 g/mol, preferably greater than 530 g/mol, more preferably greater than 535 g/mol; upper limit M (PE) less than 660 g/mol, preferably less than 630 g/mol, more preferably less than 600 g/mol.

Preferably, the value of M (PE) is greater than 520 g/mol and less than 660 g/mol, especially greater than 535 g/mol and less than 600 g/mol.

Preferably, the sum total of m +n is greater than 9 up to 19, more preferably greater than 9.5 up to 15 and especially preferably greater than 10 up to 12.

More preferably, R⁵ is hydrogen and the value of M (PE) is greater than 520 g/mol and less than 660 g/mol; especially preferably, R⁵ is hydrogen and the value of M (PE) is greater than 535 g/mol and less than 600 g/mol.

More preferably, the inventive compositions include the polyether-modified siloxanes of the formula (I) with an index c from 1 to 1.05, where the indices of the polyether radical of formula (II) are m from 3.4 to 11.0 and n from 2.5 to 8.0.

More preferably, the inventive compositions include the polyether-modified siloxanes of the formula (I) with an index c from 1 to 1.05, where the ratio m/n is 0.8 to 2.8, especially 1.9 to 2.8.

Especially preferably, the inventive compositions include the polyether-modified siloxanes of the formula (I) with an index c from 1 to 1.05, where the molar mass of the polyether residue M(PE) is greater than 520 g/mol and less than 660 g/mol.

Especially preferably, the inventive compositions include the polyether-modified siloxanes of the formula (I) with an index b=0 and c from 1 to 1.05, where the R⁵ radical is hydrogen.

Especially preferably, the inventive compositions include the polyether-modified siloxanes of the formula (I) with an index c from 1 to 1.05, where the R⁵ radical is hydrogen.

Especially preferably, the inventive compositions include the polyether-modified siloxanes of the formula (I) with an index b=0 and c between 1 and 1.05, where the molar mass of the polyether residue M(PE) is greater than 520 g/mol and less than 660 g/mol and the R⁵ radical is hydrogen.

Preferably, the inventive compositions do not include any further polyether-modified siloxanes apart from those of formula (I).

More preferred compositions of the invention contain, as solid water-soluble carrier, a polyethylene glycol having a molar mass of 2000-10 000 g/mol and, as adjuvant, a trisiloxane surfactant of the formula (I).

Even more preferred compositions of the invention contain, as solid water-soluble carrier, a bis-hydroxy-terminated polyethylene glycol having a molar mass of 2000-10 000 g/mol and, as adjuvant, a trisiloxane of the formula (I) with index a=0, b=0 to 0.1 and c from 1 to 1.05, where the molar mass of the polyether radical M(PE) is greater than 520 g/mol and less than 660 g/mol and the R⁵ radical is hydrogen.

Particularly preferred compositions of the invention contain, as solid water-soluble carrier, a bis-hydroxy-terminated polyethylene glycol having a molar mass of 2000-10 000 g/mol and, as adjuvant, a trisiloxane of the formula (I) with index a=0, b=0 to 0.1 and c from 1 to 1.05, R¹=methyl, R³═—CH₂CH₂CH₂—, where the molar mass of the polyether radical M(PE) is greater than 520 g/mol and less than 660 g/mol and the R⁵ radical is hydrogen.

Even more particularly preferred compositions of the invention contain, as solid water-soluble carrier, a bis-hydroxy-terminated polyethylene glycol having a molar mass of 2000-10 000 g/mol and, as adjuvant, a trisiloxane of the formula (I) with index a=0, b=0 to 0.1 and c from 1 to 1.05, R¹ =methyl, R³═—CH₂CH₂CH₂—, where the molar mass of the polyether radical M(PE) is greater than 520 g/mol and less than 660 g/mol and the R⁵ radical is hydrogen and the index m is 4.5 to 8.5 and n is 3.0 to 6.0, where the m/n ratio is 1.9 to 2.8.

Especially particularly preferred compositions of the invention contain, as solid water-soluble carrier, a bis-hydroxy-terminated polyethylene glycol having a molar mass of 2000-10 000 g/mol, where the carrier is laden with 5%-40% by weight of interface-active substance, based on the overall composition, with a trisiloxane of the formula (I) with index a=0, b=0 to 0.1 and c from 1 to 1.05, R¹=methyl, R³═—CH₂CH₂CH₂—, where the molar mass of the polyether radical M(PE) is greater than 520 g/mol and less than 660 g/mol and the R⁵ radical is hydrogen and the index m is 4.5 to 8.5 and n is 3.0 to 6.0, where the m/n ratio is 1.9 to 2.8.

Defoamer:

If the composition of the invention includes a defoamer as interface-active substance, it is preferably selected from the group of the polyether siloxanes. Especially preferred here are polyether siloxanes corresponding to the general formula (IV):

M_{d} Dₑ T_{f} Q_{g} Formula (IV)

M=[R^{f}₃SiO_{1/2}]

D=[R^{f}₂SiO_{2/2}]

T=[R^{f}SiO_{3/2}]

Q=[SiO_{4/2}]

where

d=2-22, preferably 2-14, especially 2,

e=3-500, preferably 10-300, especially 30-250,

f=0-16, preferably 0-8, especially 0,

g=0-10, preferably 0-6, especially 0,

where the radical R^{f} is a radical R⁶, R⁷ or R⁸, with the proviso that at least one radical R^{f} is a radical R⁷, where

R⁶ is an alkyl radical having 1 to 16, preferably 1-4, carbon atoms or an aryl radical,

R⁷ is a polyether radical of the formula (V)

—(Y)ₕ[O(C₂H₄₋ᵢR⁹O)ⱼ(CₓH₂ₓO)ₖZ¹]_{w} Formula (V)
where
h=is 0 or 1, preferably 1,
i=1 to 3, preferably 1,
j≥1 to 50, preferably 2 to 40, more preferably 3 to 30, especially preferably 5 to 20,
x=2 to 4,
k≥0 up to 20, preferably 0-15,
w=1 to 4, preferably 1,
sum of j+k=3 to 150, preferably 3-10
   R⁹=independently of the others, a hydrogen radical, a monovalent aliphatic hydrocarbon radical having 1 to 18 carbon atoms, or an aromatic hydrocarbon radical having 6-18 carbon atoms, which can optionally also be a substituted aromatic whose substituents are selected from the groups hydrogen radical, alkyl radical having 1 to 6 carbon atoms, alkoxy radical and hydroxy radical,
Z¹=independently a hydrogen radical or a monovalent organic radical, preferably hydrogen, methyl, butyl or —C(O)Me,
Y=a (w+1)-valent hydrocarbon radical having 1 to 18 carbon atoms, which can also be branched, preferably —(CH₂)₃—,
R⁸ is a polyether radical of the formula (VI)

—(F)_{q}[O(C_{z}H_{2z}O)ᵣZ²]ᵤ Formula (VI)
where
u=1 to 4, preferably 1,
q=0 or 1, preferably 1,
z=2 to 4, preferably 2,
r≥3, preferably 3-20, particularly preferably 3-16,
F=a (u+1)-valent hydrocarbon radical having 1 to 18 carbon atoms, which can also be branched, preferably —(CH₂)₃—
Z²=independently a hydrogen radical or a monovalent organic radical, preferably hydrogen, methyl, butyl or —C(O)Me,

but at least 80% of the radicals R^{f} are methyl radicals.

The siloxane backbone of the polyethersiloxanes of the formula (IV) can be straight-chain (f+g=0) or else branched (f+g>0). In the case that index h and/or index q is equal to 0, the siloxane backbone is preferably branched. In the case that indices h and q are each equal to 1, the siloxane backbone is preferably straight-chain.

The compounds of the invention are liquid at room temperature. Consequently, not all of the combinations of the values are possible for d, e, f and g. Especially when f and g are not 0, d must have a tendency to be greater than the sum of (f+g).

The values of d, e, f and g should be understood as being average values in the polymer molecule. The silicone polyether copolymers to be used in accordance with the invention are preferably in the form of equilibrated mixtures.

The R⁶ radicals are alkyl radicals having 1 to 4 carbon atoms, such as methyl, ethyl, n-propyl, n-butyl or aryl radicals, preferred aryl radicals being the phenyl radicals. Methyl radicals are preferred, and so at least 80% of the R⁶ radicals should be methyl radicals. Particular preference is given to those polyether siloxanes of the formula (II) in which all the R⁶ radicals are methyl radicals.

In the case of use of polyether siloxanes as defoamers, it is possible to use the polyether siloxanes, especially polyether siloxanes of the formula (II), individually or as mixtures. Preferably, corresponding mixtures contain polyether siloxanes, especially those of the formula (II) which differ in terms of their structure and/or their molecular weight.

Preference is additionally also given to those defoamers which contain silicone oils as active defoamer ingredient. The silicone oil here is preferably a polydimethylsiloxane. These are regarded as equivalent to the defoamers of the formula (IV).

Furthermore, preference is also given to those defoamers, which are considered to be equivalents of the defoamers of the formula (IV), which contain, as active defoamer ingredient, silicone-free compounds such as mineral oils, vegetable oils, monoglycerides of fatty acids, polyethylene waxes, stearin waxes, amide waxes or mixtures of these substances. Particular preference is given here to defoamers based on vegetable oils, especially preferably rapeseed oil. Further customary names for rapeseed oil are colza oil and rape oil. These oils are characterized by a content of oleic acid of from 51 to 70% by weight, linoleic acid of from 15 to 30% by weight and linolenic acid from 5 to 14% by weight, where still further fatty acids can be esterified with the glycerol. Reference may be made at this point to the Deutsche Gesellschaft fur Fettwissenschaft (DGF) [German Society for Fat Science],

“Fettsaurezusammensetzung wichtiger pflanzlicher und tierischer Speisefette und-öle” [Fatty Acid Composition of Important Vegetable and Animal Food Fats and Oils], http://www.dgfett.de/material/fszus.htm (20.05.2014).

Preference is further given to combination of defoamers comprising at least one polyether siloxane of the formula (II) and at least one polydimethylsiloxane.

It may be advantageous when the defoamer additionally comprises finely divided solids. These may be either inorganic or organic solids. Preferred inorganic solids are hydrophobized silicas, aluminium oxide, alkaline earth metal carbonates and/or similar solids known from the prior art and customary finely divided solids. In particular here, hydrophobized or at least partially hydrophobized silicas, such as e.g. various Aerosil or Sipernat products from Evonik Industries, are preferred. As organic solids, preference is given to alkaline earth metal salts of long-chain fatty acids having 12 to 22 carbon atoms, the amides of these fatty acids, and polyureas. The solids cited here are used in a very small amount, and so there is no risk of blockage of nozzles, since the amounts here are very much smaller than they would be in the case of use of immobilized adjuvants on silicas, for example. Preference is given here to concentrations of max. 5% by weight, based on the overall composition.

The defoamer is preferably self-emulsifying. In this connection, self-emulsifying means that the defoamer can be dispersed in water without any great input of shear and spontaneously forms emulsion droplets with an average diameter of less than 300 μm, preferably less than 200 μm, more preferably less than 100 μm. In this connection, it may in some cases be advantageous when the active defoamer ingredient is blended with emulsifier beforehand, which boosts its self-emulsifying properties. Emulsifiers used here may preferably be one or more nonionic emulsifiers.

Preferred nonionic emulsifiers are the fatty acid esters of polyhydric alcohols, their polyalkylene glycol derivatives, the polyglycol derivatives of fatty acids and fatty alcohols, alkylphenol ethoxylates, and block copolymers of ethylene oxide and propylene oxide, ethoxylated amines, amine oxides, acetylenediol surfactants and silicone surfactants. More preferably, polyglycol derivatives of fatty acids and fatty alcohols are used. Particularly preferred polyglycol derivatives are ethoxylates of fatty acids and fatty alcohols. Especially preferred are ethoxylates based on oleyl and stearyl acid or the same alcohols.

The compositions of the invention can be produced by the methods of the prior art, but they are preferably prepared by the process of the invention.

The process preferably has steps a) to c):

Step a) melting the solid water-soluble carrier and heating it to a temperature above the melting point, preferably 2 to 100° C. above the melting point, more preferably 5 to 50° C., especially preferably 10 to 30° C., above the melting point. The carrier optionally contains a certain amount of a solvent, preferably water.

Step b) adding an interface-active substance to the molten carrier from step a) while stirring, preferably without application of any great shear forces.

Step c) cooling the mixture from step c) down below the melting point, preferably to a temperature of 10 to 150° C., more preferably of 20 to 100° C., especially preferably of 30 to 50° C., below the melting point of the mixture. The cooling process is preferably conducted in such a way that the composition of the invention is converted to fine particles in the course of cooling. If the carrier contained a certain amount of a solvent, the cooling is preferably executed in such a way that the solvent is removed at the same time.

After step b), it is possible to determine the separation stability of the mixture by switching off the stirrer. If the mixture is clear, it cannot separate. If the mixture is turbid, a sample is transferred to a transparent cylindrical glass vessel, heated above the melting point as elucidated in step a) and left to stand for 1 hour. Thereafter, a visual assessment is made of whether a phase separation can be observed or the turbidity forms a gradient over the fill height. If neither is the case, the turbid mixture is regarded as finely dispersed and separation-stable.

Preferred cooling methods in step c) are spray drying and spray crystallization, more preferably spray crystallization.

If step c) is executed in such a way that the mixture is no longer in fine particulate form, an optional step d) may follow, in which the cooled mixture is mechanically comminuted. This comminution can optionally also be conducted with further cooling. It is known to the person skilled in the art that some of the preferred carrier materials pass through a vitreous state and, when the temperature is lowered further, become very brittle; in this way, it may thus be possible to lower the mechanical complexity by cooling the material to be comminuted.

One advantage of the process of the invention is that the products do not form lumps; they have very good free flow. They can thus be employed without any problem; mixing processes are simplified.

The preferred spray crystallization of a melt composed of carrier and interface-active substance is executed in step c) in such a way that the liquid melt is atomized and is sprayed into a cold air stream, the temperature of the air stream being below the solidification temperature of the carrier. This results in crystallization of the mixture. Since the mixture is in the form of a spray during the solidification, the solid carrier-active ingredient mixtures are obtainable directly in the form of a powder via spray crystallization, the particle size distribution of the powder being readily adjustable by adjustment of the droplet size in the spraying of the melt. For a more detailed description of this preferred process see, for example, C. M. Van't Land “Industrial Crystallization of Melts”, 2005, Marcel Dekker Verlag. Other solid states of matter known to those skilled in the art, for example amorphous structures, metastable crystal forms or glasses, should be regarded as equivalents of crystals.

In a further alternative method, a solution of the carrier and the interface-active substance, preferably an aqueous solution, is spray-dried. This preferably involves drying a concentrated solution at a temperature 10-200° C., preferably 20-150° C., more preferably 30-100° C., above the boiling temperature of the solvent.

In a preferred embodiment, the compositions of the invention are used as adjuvants or defoamers in crop protection formulations.

The use of the compositions of the invention as anti-drift additives likewise forms part of the subject-matter of the present invention.

Preference is given to the inventive use of the crop protection formulations including adjuvants or defoamers simultaneously as an anti-drift additive.

Preference is given here in accordance with the invention to use as additives in what are called WDG (water-dispersible granulate) formulations, WDGs being a preferred administration form in the agrichemical industry.

The use of the compositions of the invention as adjuvants in crop protection formulations is effected here with the proviso that the effectiveness of the crop protection formulation is increased by the compositions of the invention.

The use of the compositions of the invention as defoamers in crop protection formulations is effected with the proviso that foaming during use, for example in the make-up of the spray liquor, is reduced or suppressed.

The use of the compositions of the invention as anti-drift agents in crop protection formulations is effected with the proviso that the proportion of droplets capable of drift (<150 μm) in the spray mist is reduced on spraying of the crop protection formulation.

The compositions of the invention have the advantage that the water-soluble carrier dissolves completely in the spray liquor during use and hence the additive is released completely, thus avoiding losses of efficacy.

The complete dissolution of the water-soluble carrier in the spray liquor has the advantage, moreover, that there can be no blockage of the spray liquors by the carrier. Contamination of the spray tank by sticking of the carrier is likewise avoided.

As a result of the water solubility of the carrier, the compositions of the invention, moreover, have the general advantage that they can be easily incorporated into aqueous formulations, for example spray liquors.

Furthermore, the compositions of the invention have the advantage that they can be admixed easily into the pulverized WDG formulation and need no longer be mixed in liquid form into the slurry on which the WDG is based. This offers certain processing advantages according to the nature of the additive used. In the case of additives which foam significantly in water (for example trisiloxane surfactants), foaming during WDG production can thus be avoided. In the case of incompatible additives, for example defoamers, homogeneous incorporation and distribution in the WDG formulation can be achieved via the pulverized administration form.

The subsequent introduction of the solid additive composition into the pulverized WDG formulation has the advantage, moreover, that the additive is firmly embedded into its water-soluble carrier and hence cannot interact with other formulation constituents during the production of the WDGs. In this way too, losses of efficacy in application are avoided.

The invention further provides crop protection formulations comprising the solid pulverized compositions of the invention which comprise at least one solid water-soluble carrier and at least one interface-active substance.

Preference is given here to crop protection formulations comprising a crop protection agent selected from the group of acaricides (AC), algicides (AL), attractants (AT), repellents (RE), bactericides (BA), fungicides (FU), herbicides (HE), insecticides (IN), agents to combat slugs and snails, molluscicides (MO), nematicides (NE), rodenticides (RO), sterilants (ST), viridicides (VI), growth regulators (PG), plant strengtheners (PS), micronutrients (MI), macronutrients (MA) or mixtures of these substances; such substances and their field of application are known to the person skilled in the art. Some of these active ingredients or active organisms are listed for example in “The Pesticide Manual”, 14th edition, 2006, The British Crop Protection Council, or in “The Manual of Biocontrol Agents”, 2004, The British Crop Protection Council. However, the present application is not only limited to these active ingredients listed therein.

A further advantage of the use of the invention is the rapid rise in efficacy. This opens up the option of an extension of the application window to the user. It is thus also possible to treat plants which are already older without the risk that fruits will form before they die off. This effect is known to the person skilled in the art by the term “premature maturation”.

### EXAMPLES

General Methods and Materials

Substances:

Break-Thru® S200, Break-Thru® S233, Break-Thru® S240, Break Thru® S301 (trademark of Evonik Industries AG); polyether-modified trisiloxane surfactants Tego Antifoam KS 53 (trademark of Evonik Industries AG); vegetable oil-based active defoamer ingredient comprising nonionic surfactants and silica

Tego Antifoam 793 (trademark of Evonik Industries AG); polyether siloxane-based active defoamer ingredient comprising silica

PEG 6000 from Sasol Germany GmbH

Hostapur SAS 30 is anionic surfactant (secondary alkylsulphonate sodium salt) from Clariant

### Example 1

### Production of Solid Trisiloxane Compositions

For production of the compositions of the invention, polyethylene glycol having a mean molar mass of 6000 g/mol (PEG 6000) was used as water-soluble carrier. 100 g of this carrier were melted in a beaker at 75° C. The trisiloxane surfactants listed in Table 1 were added to this melt with constant stirring. The corresponding weights are likewise listed in Table 1. In all cases, it was observed here that homogeneous, clear mixtures of PEG 6000 and the trisiloxane formed after a short time. These mixtures were subsequently poured into an aluminium dish for solidification and comminuted, and then ground with a laboratory grinder to give a powder.

TABLE 1
Inventive compositions consisting of trisiloxane surfactant
and PEG 6000 as solid water-soluble carrier

| Sample | Adjuvant | Weight [g] | Product form |
|---|---|---|---|
| P1 | Break-Thru ® S200 | 25 | free-flowing powder |
| P2 | Break-Thru ® S200 | 42.8 | free-flowing powder |
| P3 | Break-Thru ® S233 | 25 | free-flowing powder |
| P4 | Break-Thru ® S233 | 42.8 | free-flowing powder |
| P5 | Break-Thru ® S240 | 25 | free-flowing powder |
| P6 | Break-Thru ® S240 | 42.8 | free-flowing powder |
| P7 | Break-Thru ® S301 | 25 | free-flowing powder |
| P8 | Break-Thru ® S301 | 42.8 | free-flowing powder |

### Example 2

### Production of Solid Defoamer Compositions

For production of solid defoamer compositions, polyethylene glycol having a mean molar mass of 6000 g/mol (PEG 6000) was used as water-soluble carrier. 100 g of this carrier were melted in a beaker at 75° C. The active defoamer ingredients listed in Table 2 were added to this melt with constant stirring. These mixtures were subsequently poured into an aluminium dish for solidification and comminuted, and then ground with a laboratory grinder to give a powder. In all cases, it was observed here that a turbid but sufficiently separation-stable dispersion of the active defoamer ingredients in PEG 6000 was formed, which could be solidified without phase separation.

TABLE 2
Inventive compositions consisting of active defoamer ingredients
and PEG 6000 as solid water-soluble carrier

| Sample | Adjuvant | Weight [g] | Product form |
|---|---|---|---|
| P9 | Tego Antifoam KS 53 | 25 | free-flowing powder |
| P10 | Tego Antifoam KS 53 | 42.8 | free-flowing powder |
| P11 | Tego Antifoam 793 | 25 | free-flowing powder |
| P12 | Tego Antifoam 793 | 42.8 | free-flowing powder |

### Example 3

### Free Flow of the Powders

To determine flowability (free flow) without pressure treatment, siliconized glass orifice vessels with different orifice diameters were used (according to literature: Seifen, Öle, Fette, Wachse 1968, 94, 12). The assessment was made according to the grades: 1=very good flow characteristics (the powder to be examined flows continuously out of orifice vessel no. 1 having the smallest orifice) down to grade 6=inadequate flow characteristics (the powder does not flow even out of measurement vessel no. 5 having the largest orifice). The measurement method was conducted always with the same sequence of orifice vessels 6 to 1. What was determined was the measurement vessel in which the pulverized composition still just flows out continuously. For each sample, 10 experiments were undertaken and the average in each case was calculated, rounding to half marks.

The experiments show that the free flow of all inventive samples is at least good.

### Example 4

### Defoaming Tests

The defoaming effect was tested in a 0.2% solution of the anionic surfactant Hostapur SAS 30. 1 litre of this solution was introduced into a 2 litre measurement cylinder, 100 mg in each case of the solid defoamer composition to be examined were added (samples P9 to P12) and homogenized with gentle stirring. It was observed here that all compositions of the invention had good homogenizability. Subsequently, air was passed with a defined volume flow rate of 600 ml/min through this solution via a glass frit for 60 minutes. After these 60 minutes, it was possible in all cases to observe foaming of <500 ml. Additionally introduced as a reference was an experiment in which, under the same conditions, air was passed through a defoamer-free Hostapur solution. It was possible here to observe foaming of >1000 ml after only 4 min, and so it was necessary to stop the experiment early.

### Example 5

### Use as Adjuvant

Experiments: The effect of the inventive composition P7 as a tankmix additive on the action of Cato (rimsulfuron) was examined—greenhouse screening versus Echinochloa crus-galli (barnyard grass), Galium aparine (cleavers) and Matricaria spec. (chamomile).

The plants were cultivated for four weeks in Fruhstorfer soil (specialty mixture “fine”). At the time of application, the plants were at the 3-4 leaf stage. The spray liquors were applied with a membrane pump under a fume hood. The concentration of Cato (rimsulfuron) for foliar application to entire plants was set to 40 g/ha(N) or 20 g/ha (N/2). The herbicidal action was evaluated after 2, 3 and 4 weeks as a function of action, WAT (week after treatment).

An effect of 60% is classified as poor, between 60% and 80% as moderate, 80% to 90% as good, 90% to 95% as very good and more than 95% as excellent. The maximum value is 100%.

Results:

The efficacy of Cato on Matricaria spec. in both dosages after 2 WAT, depending on the dose, was in the moderate range between 74% and 80%, such that differentiation between the test preparations was possible (Tab. 3). This improvement in the effect was particularly clear with P7 at >90%.

3 WAT with the test preparations achieved a comparable efficacy to the higher dosage of Cato.

TABLE 3
Efficacy (%) versus Matricaria spec. (chamomile)
two and three weeks after treatment

| | Efficacy | Efficacy |
|---|---|---|
| Trial element | [%], 2 WAT | [%], 3 WAT |
| Cato 40 g/ha | 80.0 | 97.5 |
| Cato 20 g/ha | 73.8 | 82.5 |
| Cato 20 g/ha + P7 in 100 g/ha | 77.5 | 82.5 |
| Cato 20 g/ha + P7 in 250 g/ha | 95.0 | 100.0 |

The sole application of Cato to Galium aparine led to a moderate effect of 71% in the low dosage of 20 g/ha and an already good effect of 84% in the higher dosage of 40 g/ha.

With P7, it was possible to achieve a distinct rise in efficacy.

TABLE 4
Efficacy (%) versus Galium aparine three weeks after treatment

| | Efficacy |
|---|---|
| Trial element | [%], 3 WAT |
| Cato 40 g/ha | 83.8 |
| Cato 20 g/ha | 71.3 |
| Cato 20 g/ha + P7 in 100 g/ha | 77.5 |
| Cato 20 g/ha + P7 in 250 g/ha | 91.3 |

The initial efficacy of Cato on Echinochloa crus-galli was in the lower moderate region and, depending on the dose, was 71% or 76% (Tab. 5). However, even at this early juncture, 2 WAT, an improvement in the efficacy of Cato by P7 was recorded. 3 WAT the improved efficacy resulting from P7 was clearly apparent, and this peaked 4 WAT in 100% control of Echinochloa crus-galli.

TABLE 5
Efficacy (%) versus Echinochloa crus-galli
two, three and four weeks after treatment

| | Efficacy | Efficacy | Efficacy |
|---|---|---|---|
| Trial element | [%], 2 WAT | [%], 3 WAT | [%], 4 WAT |
| Cato 40 g/ha | 76.3 | 78.8 | 83.8 |
| Cato 20 g/ha | 71.3 | 73.8 | 78.8 |
| Cato 20 g/ha + P7 in 100 g/ha | 78.8 | 80.0 | 95.0 |
| Cato 20 g/ha + P7 in 250 g/ha | 90.0 | 92.5 | 100.0 |

The experiments showed that the inventive use led to an absolute improvement in efficacy and a faster rise in efficacy over time. Moreover, even a small dosage of the pesticides led to better efficacy compared to the use of the pesticide without the inventive composition P7 even after a prolonged period. The inventive use resulted in observation of considerable shortening of the treatment time. In the case of Echinochloa, which is difficult to control, the shortening was actually by half with already very good efficacy.

1. A solid pulverized composition, comprising
at least one solid water-soluble carrier and at least one interface-active substance, wherein the water-soluble carrier is at least one polymeric material selected from the group consisting of
(a) a homopolymer based on a monomer or a copolymer containing two or more monomers selected from the group consisting of ethylene oxide, an alkylene oxide other than ethylene oxide, ethylene glycol, an alkylene glycol other than ethylene glycol, ethyleneimine, (meth)acrylic acid, (meth)acrylamide, aminoalkyl (meth)acrylate, hydroxyethyl (meth)acrylate, vinyl alcohol, vinylpyrrolidone, and vinylimidazole,
(b) a cyclodextrin, and
(c) a cellulose derivative.

2. The solid pulverized compositions according to claim 1, wherein the water-soluble carrier is at least one homopolymer selected from the group consisting of polyvinyl alcohol, poly(meth)acrylic acid, poly(meth)acrylamide, polyvinylpyrrolidone, polyhydroxyethyl(meth)acrylate, polyaminoalkyl(meth)acrylate, polyvinylimidazole, polyethyleneimine, and polyethylene glycol.

3. The solid pulverized compositions according to claim 1, wherein the polymeric carrier material has a molar mass of 600-20 000 g/mol.

4. The solid pulverized compositions according to claim 1, wherein the water-soluble carrier is laden with 1%-75% by weight of the at least one interface-active substance, based on a total weight of the composition.

5. The solid pulverized compositions according to claim 1, wherein the interface-active substance is a polyether siloxane.

6. The solid pulverized compositions according to claim 1, wherein the interface-active substance is at least one polyether siloxane of formula (I):
MₐD_{b}D′_{c} Formula (I)
with M=R¹₃SiO_{1/2}, D=R¹₂SiO_{2/2}, D′=R¹R²SiO_{2/2},
where
a is 2,
b is from 0 to 0.1,
c is from 1.0 to 1.15,
each R¹ is independently a hydrocarbyl having 1 to 8 carbon atoms,
each R² is independently a polyether radical of formula (II)
—R³O[CH₂CH₂O]ₘ[CH₂CH(CH₃)O]ₙR⁵ Formula (II)
where
m=3.4 to 11.0,
n=2.5 to 8.0,
but with the provisos that:
m/n =0.44 to 3.08,
each R³ is independently a divalent hydrocarbyl radical having 2 to 8 carbon atoms,
each R⁵ is independently a hydrocarbyl radical having 1 to 16 hydrocarbons or hydrogen.

7. The solid pulverized compositions according to claim 1, wherein the interface-active substance is a polyether siloxane of formula (IV):
M_{d} Dₑ T_{f} Q_{g} Formula (IV)
M=[R^{f}₃SiO_{1/2}]
D=[R^{f}₂SiO_{2/2}]
T=[R^{f}SiO_{3/2}]
Q=[SiO_{4/2}]
where
d=2 to 22,
e=1 to 500,
f=0 to 16, and
g=0 to 10,
where R^{f} is a radical R⁶, R⁷ or R⁸, with the proviso that at least one radical R^{f} is a radical R⁷ and at least 80% of R^{f} are methyl radicals, where
R⁶ is an alkyl radical having 1 to 16 carbon atoms or an aryl radical,
R⁷ is a polyether radical of formula (V)
—(Y)ₕ[O(C₂H₄₋ᵢR⁹O)ⱼ(CₓH₂ₓO)ₖZ¹]_{w} Formula (V)
where
h=is 0 or 1,
i=1 to 3,
j≥1 to 50,
x=2 to 4,
k≥0 up to 20,
w=1 to 4,
j+k=3 to 150,
each R⁹ is independently a hydrogen radical, a monovalent aliphatic hydrocarbon radical having 1 to 18 carbon atoms, or an aromatic hydrocarbon radical having 6-18 carbon atoms, which is optionally a substituted aromatic having at least one substituent selected from the group consisting of hydrogen, an alkyl radical having 1 to 6 carbon atoms, an alkoxy radical and a hydroxyl radical,
each Z¹ is independently a hydrogen radical or a monovalent organic radical,
Y is a (w+1)-valent hydrocarbyl radical which has 1 to 18 carbon atoms and is optionally branched,
R⁸ is a polyether radical of formula (VI)
—(F)_{q}[O(C_{z}H_{2z}O)ᵣZ²]ᵤ Formula (VI)
where
u=1 to 4,
q=0 or 1,
z=2 to 4,
r≥3,
F is a (u+1)-valent hydrocarbon radical having 1 to 18 carbon atoms, which is optionally branched,
each Z² is independently a hydrogen radical or a monovalent organic radical.

8. The solid pulverized compositions according to claim 1, wherein the interface-active additive is finely dispersed in the solid water-soluble carrier.

9. A process for producing the solid pulverized compositions according to claim 1, the process comprising
embedding the at least one interface-active substance into the at least one solid water-soluble carrier.

10. The process according to claim 9, comprising:
heating the solid water-soluble carrier to a temperature above a melting point of the solid water-soluble carrier, which optionally contains a certain amount of a solvent, thereby obtaining a molten carrier,
adding the interface-active substance to the molten carrier while stirring, thereby obtaining a mixture, and
cooling the mixture to a temperature below a melting point, of the mixture.

11. An aqueous solution, comprising
the solid pulverized compositions according to claim 1.
